(19) United States
(12) Patent Application Publication
(10) Pub. No.: US 2013/0316199 A1
(43) Pub. Date: Nov. 28, 2013

(54) ELECTROCHEMICAL BALANCE IN A VANADIUM FLOW BATTERY

(71) Applicant: DEEYA ENERGY, INC., Fremont, CA (US)

(72) Inventors: Majid Keshavarz, Pleasanton, CA (US); Ge Zu, San Jose, CA (US); Gilles Y. Champagne, Sainte-Julie, CA (US); Reinder J. Boersma, Webster, MA (US)

(21) Appl. No.: 13/843,085

(22) Filed: Mar. 15, 2013

Related U.S. Application Data
(60) Provisional application No. 61/651,943, filed on May 25, 2012.

(51) Int. Cl. H01M 8/18

(52) U.S. Cl. CPC H01M 8/18
USPC 429/51; 429/105

(57) ABSTRACT

A Flow Cell System that utilizes a Vanadium Chemistry is provided. The flow cell system includes a stack, storage tanks for electrolyte, and a rebalance system coupled to correct the electrolyte oxidation state. Methods of rebalancing the negative imbalance and positive imbalance in the flow cell system are also disclosed.

### REFERENCE TO RELATED APPLICATIONS

The present invention claims priority to U.S. Provisional Application No. 61/651,943, entitled “Electrochemical Balance In A Vanadium Flow Battery”, filed on May 25, 2012, the content of which are herein incorporated by reference in its entirety.

### BACKGROUND

1. Technical Field

The present disclosure relates to a flow cell system and, in particular, to a rebalancing in a flow cell system that uses a Vanadium based chemistry.

2. Discussion of Related Art

There is an increasing demand for novel and innovative electric power storage systems. Redox flow cell batteries have become an attractive means for such energy storage. In certain applications, a redox flow cell battery may include one or more redox flow cells. Each of the redox flow cells may include positive and negative electrodes disposed in separate half-cell compartments. The two half-cells may be separated by a porous or ion-selective membrane, through which ions are transferred during a redox reaction. Electrolytes (anolyte and catholyte) are flowed through the half-cells as the redox reaction occurs, often with an external pumping system. In this manner, the membrane in a redox flow cell battery operates in an aqueous electrolyte environment.

In order to provide a consistent supply of energy, it is important that many of the components of the redox flow cell battery system are performing properly. Redox flow cell battery performance, for example, may change based on parameters such as the state of charge, temperature, electrolyte level, concentration of electrolyte and fault conditions such as leaks, pump problems, and power supply failure for powering electronics.

Vanadium based flow cell system have been proposed for some time. However, there have been many challenges in developing a Vanadium based system that is economically feasible. These challenges include, for example, the high cost of the Vanadium electrolyte, the high cost of appropriate membranes, the low energy density of dilute electrolyte, thermal management, impurity levels in the Vanadium, inconsistent performance, stack leakage, membrane performance such as fouling, electrode performance such as delamination and oxidation, rebalance cell technologies, and system monitoring and operation.

Therefore, there is a need for better redox flow cell battery systems using Vanadium chemistries.

### SUMMARY

In accordance with some embodiments, a flow cell system with a rebalance system is disclosed. In some embodiments, a flow cell system includes a stack of flow cells; a plurality of electrolyte storage tanks coupled to provide electrolyte to the stack and to receive electrolyte from the stack; and a rebalance system coupled to adjust the electrolyte stored in the plurality of electrolyte storage tanks.

A method for rebalancing the positive imbalance according to some embodiments of the present invention includes introducing reducing agents. In other embodiments, electrolyte having V⁴⁺/V⁵⁺ may be exchanged with electrolyte having V²⁺/V³⁺ in a controlled manner to rebalance the positive imbalance.

A method for rebalancing the negative imbalance according to some embodiments of the present invention includes introducing oxidizing agents. In other embodiments, air may be flowed into the flow cell system to rebalance the negative imbalance. Further in other embodiments, electrolyte having V²⁺/V³⁺ may be exchanged with electrolyte having V⁴⁺/V⁵⁺ in a controlled manner to rebalance the negative imbalance.

These and other embodiments will be described in further detail below with respect to the following figures.

### BRIEF DESCRIPTION OF THE DRAWINGS

FIG. 1A illustrates a flow cell system according to some embodiments of the present invention.

FIG. 1B illustrates a Vanadium chemistry that can be used in the flow cell system illustrated in FIG. 1A.

FIG. 2 illustrates an example rebalance system according to some embodiments of the present invention.

FIG. 3 shows some rebalance data utilizing an embodiment of the rebalance system illustrated in FIG. 2.

FIG. 4 shows some rebalance data utilizing an embodiment of the rebalance system illustrated in FIG. 2.

FIG. 5 illustrates another example rebalance system according to some embodiments of the present invention.

FIG. 6 shows a graph of Open Circuit Voltage (OCV) as a function of the State of Charge (SOC) of a flow cell system using 2M Vanadium in 4 M HCl as electrolyte at 26 C and 45 C temperatures.

FIG. 7 shows some rebalance data utilizing an embodiment of the rebalance system illustrated in FIG. 1A.

The drawings may be better understood by reading the following detailed description. The drawings are not to scale.

### DETAILED DESCRIPTION

It is to be understood that the present invention is not limited to particular devices or methods, which may, of course, vary. It is also to be understood that the terminology used herein is for the purpose of describing particular embodiments only, and it is not intended to be limiting.

A Vanadium Flow Cell system that utilizes a vanadium based chemistry is disclosed. Groups have investigated vanadium/vanadium electrolytes in H₂SO₄. In that effort, V₂O₅+V₂O₃+H₂SO₄ yields VOSO₄. An electrochemical reduction of V₂O₅+H₂SO₄ can also yield VOSO₄. However, preparation of the electrolyte has proved difficult and impractical. Another group has tried a mixture of H₂SO₄ and HCl by dissolving VOSO₄ in HCl. However, again the electrolyte has proved to be expensive and impractical to prepare sulfate free formulation. A sulfate free Vanadium electrolyte that can be utilized in this system is further described in U.S. patent application Ser. No. 13/651,230, which is herein incorporated by reference in its entirety.

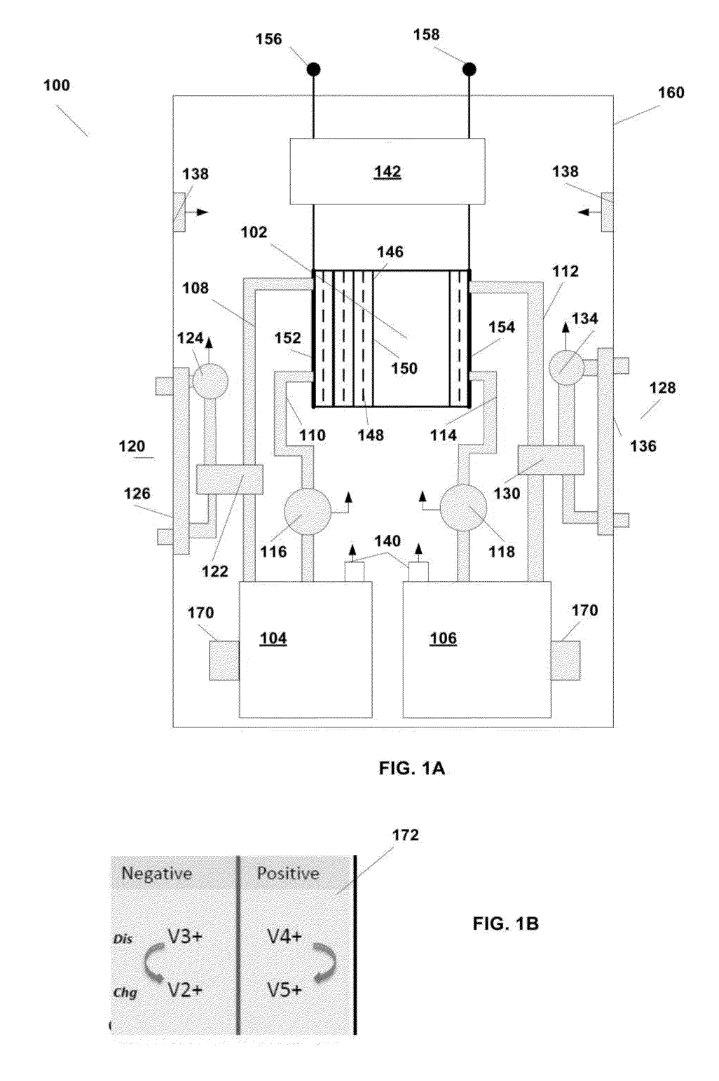

FIG. 1A conceptually illustrates a flow cell system 100 according to some embodiments of the present invention. As shown in FIG. 1A, flow cell system 100 includes a stack 102. Stack 102 is a stacked arrangement of individual flow cells 146, each flow cell 146 including two half-cells separated by a membrane 148. Membrane 148 can be an ion permeable membrane as described, for example, in U.S. Pat. No. 7,927,731, which is herein incorporated by reference in its entirety. Further, each half-cell of cell 146 includes an electrode 150. The end cells include end electrodes 152 and 154. A controller 142 is coupled to end electrodes 152 and 154 to control charge into and out of stack 102. Controller 142 provides charge from stack 102 to terminals 156 and 158 when system 100 is discharging and receives charge from terminals 156 and 158 to provide to stack 102 when charging. Terminals 156 and 158 are, in turn, coupled to supply current to a load when system 100 is discharging and coupled to a current source (e.g., a wind generator, solar cells, diesel generator, power grid, or other source of power) for charging of system 100.

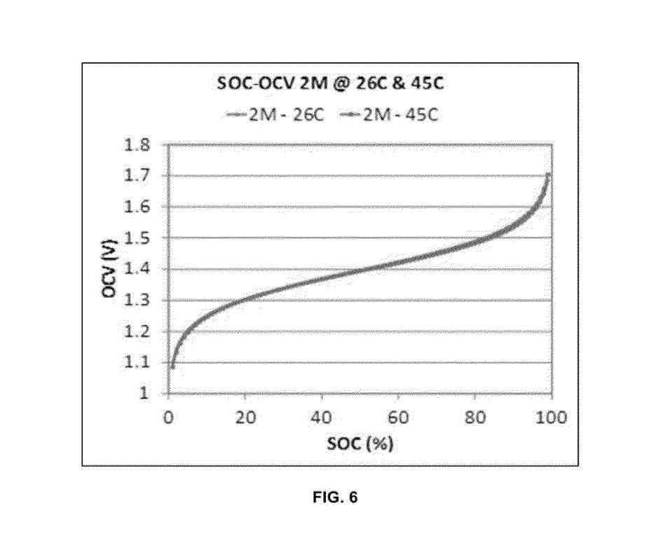

As illustrated in FIG. 1A, electrolyte solutions are flowed through each of the half cells of cells 146. A catholyte is flowed through one of the half-cells and an anolyte is flowed through the other of the half cells. Although other chemistries have been proposed for use in system 100, in some embodiments a Vanadium based chemistry is utilized to hold charge and provide charge from stack 102. The Vanadium chemistry involves the reaction of V³⁺+e⁻→V²⁺ in the negative half-cell of cell 146 and VO²⁺+H₂O→VO₂⁺+2H⁺+e⁻ (V⁴⁺→V⁵⁺+e⁻) in the positive half cell of cell 146. The theoretical open circuit voltage of each cell in stack 102 utilizing the Vanadium chemistry is then 1.25V, (−0.25 V from one half-cell and 1.00V from the other half-cell 108), the actual open circuit voltage for this chemistry is 1.41 V, as is illustrated in FIG. 6. FIG. 6 illustrates the Open Circuit Voltage as a function of State-of-Charge for V chemistries with 2M Vanadium in 4M HCL at temperatures of 26 C and 45 C. As illustrated in FIG. 6, the Open Circuit Voltage is about 1.41V at 50% SoC. The ions H⁺ and Cl⁻ may traverse membrane 148 during the reaction.

As illustrated in FIG. 1A, the electrolytes are stored in tanks 104 and 106. Tank 104 is fluidly coupled to stack 102 through pipes 108 and 110. The electrolyte stored in tank 104 can be pumped through stack 102 by a pump 116. Similarly, tank 106 is fluidly coupled to stack 102 through pipes 112 and 114. Electrolyte from tank 106 can be pumped through stack 102 by pump 118.

As shown in FIG. 1A, system 100 is housed in a cabinet 160. During the operation of system 100, a significant amount of heat may be generated by system 100, and particularly in stack 102. In some embodiments, cooling fans 138 may be provided. A temperature control system according to some embodiments has been described in U.S. Pat. No. 7,919,204, which is herein incorporated by reference in its entirety.

As is further shown in FIG. 1, system 100 can include electrolyte cooling systems 120 and 128, which cools the electrolyte returning from stack 102 into tanks 104 and 106, respectively. As shown, electrolyte from stack 102 flowing through pipe 108 can flow through electrolyte heat exchanger 122. Similarly, electrolyte from stack 102 that flows through pipe 112 can flow through electrolyte heat exchanger 130. Each of exchangers 122 and 130 can cool electrolytes utilizing a cooling liquid that is flowed through electrolyte exchangers 122 and 130 and itself cooled by heat exchangers 126 and 136, respectively. Pumps 124 and 134, respectively, can circulate the cooling fluid through heat exchangers 126 and 136, respectively, and through heat exchangers 126 and 136, respectively.

As is further illustrated in FIG. 1A, a control system 142 controls various aspects of system 100. Control system 142 controls the operation of stack 102 and electrolyte pumps 116 and 118 to charge and discharge system 100. Control system 142 can also control cooling fans 138 and cooling fluid pumps 124 and 134 to control the cooling of system 100. Control system 142 can receive signals from various sensors 140 that provide data regarding the operation of system 100. Control system 142 can include, for example, a fluid level sensor such as that described in U.S. patent application Ser. No. 12/577,147; level detectors such as that described in U.S. patent application Ser. No. 12/790,794; or optical leak detectors such as that described in U.S. patent application Ser. No. 12/790,749, each of which is herein incorporated by reference in its entirety.

The flow cell system 100 illustrated in FIG. 1A is further described in U.S. patent application Ser. No. 13/842,446, filed on Mar. 15, 2013, which is herein incorporated by reference in its entirety.

As is further shown in FIG. 1A, each of tanks 104 and 106 may be coupled with a rebalance system 170. Rebalance system 170 can be used with vanadium chemistries, regardless of the solvent or solution used (sulfates, chlorides, or mixed). As discussed above, a Vanadium in HCl electrolyte can be used in system 100, as is further described in U.S. patent application Ser. No. 13/651,230, which is herein incorporated by reference in its entirety. In order to optimize the performance of system 100 and to increase the life cycle of the electrochemical storage, the electrochemical balance of the redox reactants stored in tanks 104 and 106 may be maintained. Gas evolution/intrusion or side reactions at both sides of the electrochemical cells 146 in stack 102 can cause one of the reactant to become more charged than the other reactant. To maintain the electrochemical balance of the redox reactants, the system operation at high state of charge and/or high temperature can be limited due to side reactions.

In some embodiments, the following reactions may occur in electrochemical cells 146 of stack 102. During charging, the Positive Half Cell (or Catholyte) transitions V⁴⁺→V⁵⁺:

VOCl₂+H₂O+Cl→VO₂Cl+2HCl+e⁻. (1)

The Negative Half Cell (or Anolyte) transitions V³⁺→V²⁺:

VCl₃+e⁻→VCl₂+Cl⁻. (2)

In both sides of the cell, the following reactions may occur (V⁴⁺+V³⁺→V⁵⁺+V²⁺):

VOCl₂+H₂O+VCl₃→VO₂Cl+2HCl+VCl₂ (3)

These reactions are illustrated diagrammatically in reaction diagram 172 in FIG. 1B. The cell shown in FIG. 1A may use different reactions and different electrolyte chemistries than those described above. The above description is for exemplary purposes only.
In both the positive and negative side of cell 146, side reactions occur that can lead to imbalances. Side reactions that lead to a negative imbalance in the positive half-cell may include Electrochemical Oxidation reactions such as, for example:

H₂O→O₂, (4)

Cl⁻→½Cl₂, and (5)

C→CO₂. (6)

Further, Chemical Reduction (using a reducing agent) can result in the reaction

V⁵⁺→V⁴⁺, (7)

where the reducing agent may be organic reducing agents like, for example, alcohol, methanol, ethylene glycol, glycerol, organic acid, formic acid, oxalic acid, or other agent. Carbon electrode or CF ions can also be used. A further list of appropriate reducing agents for reduction of V⁵⁺ is presented in the U.S. patent application Ser. No. 13/651,230, which is herein incorporated by reference in its entirety.

Side reactions that lead to a positive imbalance in the negative half cell may include Electrochemcical Reduction, for example

H⁺→½H₂, (8)

or Chemical Oxidation (O₂ Intrusion), for example

V²⁺→V³⁺. (9)

Rebalance system 170 may operate differently to correct for the negative imbalance than for correction of the positive imbalance. To correct the negative imbalance, which means the molar amount of V²⁺ is higher than the molar amount of V⁵⁺ at any given state of charge ([V²⁺]>[V⁵⁺]), O₂ (air) oxidation may be used to correct for excess V²⁺, as shown in reaction 10:

V²⁺+O₂→V³⁺ (10)

This reaction may be accomplished by introducing air in any way into the system, for example, by bubbling or blowing air into system 100 (e.g., into the holding tank of the electrolyte). Such a process may be controlled by controller 142. For example, an exhaust can be used to intrude O₂ in a controlled fashion into system 100. Alternatively, other oxidizing agents like hydrogen peroxide, chlorine, or vanadium salt in 5+ or 4+ oxidation state. or other agent may be introduced into system 100. Additionally, there may be some volume exchange (by exchanging negative electrolyte (i.e. V²⁺/V³⁺ electrolyte) with positive electrolyte (i.e. V⁴⁺/V⁵⁺ electrolyte) in a controlled fashion. A nominal percent of electrolyte volume at a time can be introduced into the field servicing for system 100.

To correct the positive imbalance, which means the molar amount of V⁵⁺ is higher than the molar amount of V²⁺ at any given state of charge ([V⁵⁺]>[V²]), reducing agents may be added to the positive side. This may be accomplished by dripping mild organic reducing agents like alcohols (ROH, where R is a hydrocarbon), for example methanol or ethylene glycol or glycerol or other reducing agents. Such addition can be accomplished in a controlled fashion in rebalance system 170 under the direction of controller 142. Further, as discussed above, volume exchange may be performed by exchanging V⁴⁺/V⁵⁺ electrolyte with externally added V²⁺/V³⁺ electrolyte sources. In volume swapping, a nominal percent of electrolyte volume can be exchanged at a time (for example, as part of the field service).

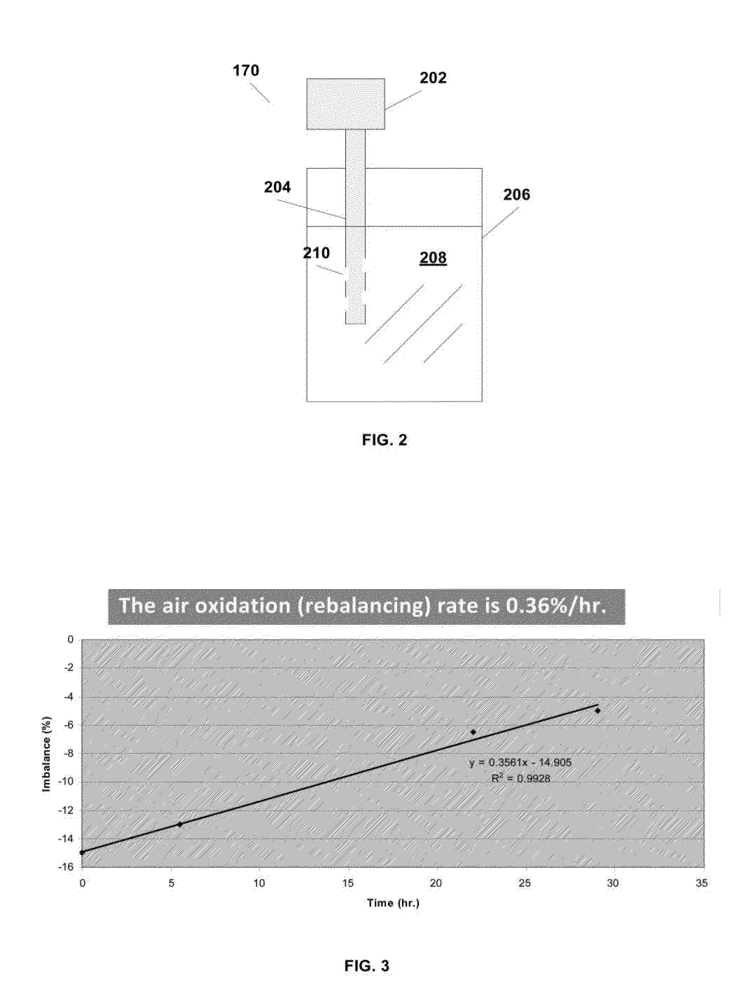

FIG. 2 illustrates an example rebalance system 170 for correcting a negative imbalance. The embodiment of rebalance system 170 illustrated in FIG. 2 includes an air pump 202 coupled to an injector tube 204. Injector tube 204 is inserted into holding tank 206 such that air can be released into electrolyte 208 through small holes 210 in injector tube 204.

FIG. 3 illustrates a graph of data utilizing an embodiment of rebalance system 170 as shown in FIG. 2. The data is taken with an aquatic air pump that delivers 1.4 L/min of air at up to 2.9 psi. Injector tube 204 includes one or multiple small holes (0.040″ in diameter) located at about 13″ below the electrolyte level. The electrolyte volume, for example, can be 400 liter and vanadium concentration is 1.25M and Hydrochloric acid concentration is 4 M. As shown, the imbalance amount is reduced from about −15% to about −5% in about 29 hours. As illustrated in the graph, the relationship between the imbalance amount and rebalance time is roughly linear with a rebalance rate at about 0.36%/hr. Data illustrated in the graph of FIG. 3 is provided in Table I below.

TABLE I

| Rebalancing Time (hr.) | Imbalance (%) |
|---|---|
| 0 | −15 |
| 5.5 | −13 |
| 22 | −6.5 |
| 29 | −5.0 |

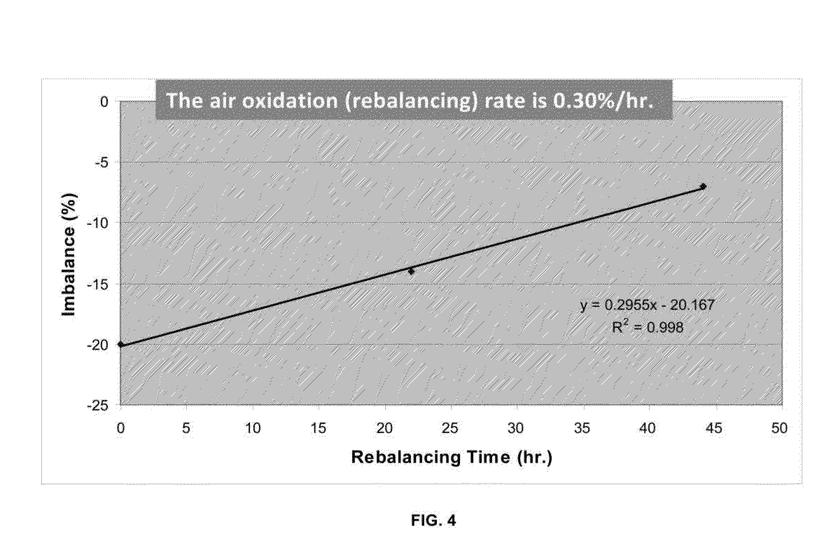

FIG. 4 illustrates a graph of data utilizing another embodiment of rebalance system 170 as shown in FIG. 2. The data is taken with an aquatic pump delivering 2.5 L/min of air at a pressure of up to 2.9 psi. Injector tube 204 includes one or multiple small holes (0.27″ in diameter) located at about 2″ above the end of the tube, which is lowered to the same depth in electrolyte 208 as in the data illustrated in FIG. 3 (the holes are about 13″ below the level of the electrolyte). The electrolyte volume, for example, can be 400 liter and vanadium concentration is 1.25M and Hydrochloric acid concentration is 4 M. In this case, the imbalance amount also decreases linearly with rebalance time, with a rebalance rate at about 0.30%/hr. The data used in producing the graph in FIG. 4 is provided in Table II below.

| Rebalance time (hr.) | Imbalance (%) |
|---|---|
| 0 | −20 |
| 22 | −14 |
| 44 | −7 |

As illustrated in FIGS. 3 and 4, air oxidation is an effective and reliable way to rebalance by oxidation. Air oxidation is a mild exothermic reaction, but during the experiments, there was no sign of electrolyte temperature increase at a rebalance rate of 0.3%-0.4%/hr.

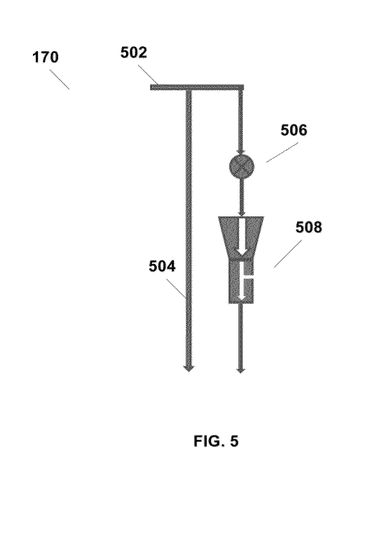

FIG. 5 illustrates another embodiment of rebalance system 170 that can be utilized to oxidize electrolyte 208. In this case, a Venturi pump is utilized to draw air into the electrolyte as it passes through the return line back to the holding tank. As shown in FIG. 1, electrolyte flows through pipe 108 back to tank 104 and through pipe 112 back to tank 106. As illustrated in FIG. 5, a bypass can be inserted into return line 502, which can be either pipe 108 or 112 as needed. A Venturi pump 508 may introduce air into the electrolyte stream before it re-enters the holding tank. Flow to Venturi pump 508 can be controlled by valve 506, which may be a solenoid valve controlled by controller 142.

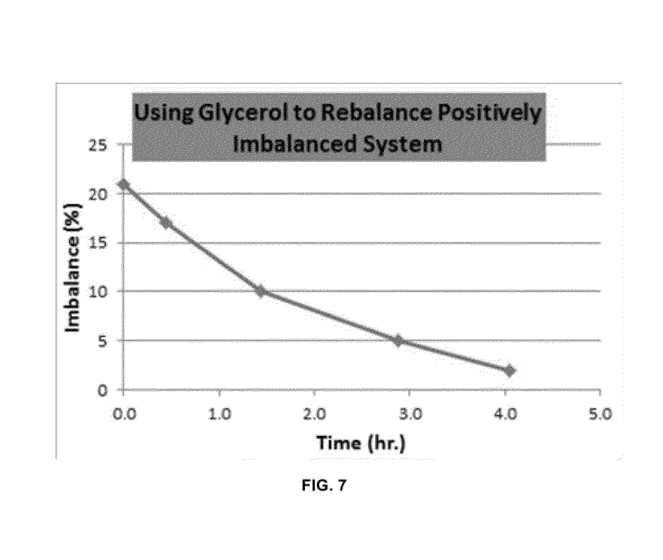

FIG. 6 shows the dependence of Open Circuit Voltage (OCV) on State of Charge (SOC). The data was taken using 2M Vanadium in 4M HCl as a sulfate free electrolyte. Data was taken at 26 C and at 45 C. FIG. 7 illustrates data utilizing another embodiment of rebalance system 170 as shown in FIG. 1A. As shown in FIG. 7, glycerol can be used as a reducing agent to rebalance a positive imbalance. The data illustrated in FIG. 7 is taken after 605 mL glycerol was added into catholyte tank 104. The electrolyte volume can be, for example, 400 liter and vanadium concentration is 1.25M and Hydrochloric acid concentaration is 4 M. As shown, the electrochemical imbalance is reduced from 21% to about 2% in about 4 hours; the process is accompanied by generation od carbon dioxide as byproduct During the process, electrolyte temperature increased by about 2° C.

In the preceding specification, various embodiments have been described with reference to the accompanying drawings. It will, however, be evident that various modifications and changes may be made thereto, and additional embodiments may be implemented, without departing from the broader scope of the invention as set for in the claims that follow. The specification and drawings are accordingly to be regarded in an illustrative rather than restrictive sense.

What is claimed is:

1. A flow cell system, comprising:
a stack of flow cells;
a plurality of electrolyte storage tanks coupled to provide electrolyte to the stack and to receive electrolyte from the stack; and
a rebalance system coupled to adjust the electrolyte stored in the plurality of electrolyte storage tanks.

2. The flow cell system of claim 1, wherein the rebalance system introduces a reducing agent to the electrolyte to correct a positive imbalance.

3. The flow cell system of claim 2, wherein the reducing agent includes a mild organic reducing agent comprising at least one of alcohol, methanol, ethylene glycol, glycerol, organic acid, formic acid, oxalic acid and glycerol.

4. The flow cell system of claim 1, wherein the rebalance system introduces oxidation to correct a negative imbalance.

5. The flow cell system of claim 4, wherein the rebalance system includes an air pump coupled to an injector tube.

6. The flow cell system of claim 4, wherein the rebalance system includes a Venturi pump, and a valve coupled to an injector tube.

7. The flow cell system of claim 4, wherein the rebalance system introduces an oxidizing agent to the electrolyte to correct the negative imbalance.

8. The flow cell system of claim 7, wherein the oxidizing agent is comprised of at least one of oxygen, hydrogen peroxide, chlorine, or vanadium ion in oxidation state 5+ or 4+

9. The flow cell system of claim 1, wherein electrolyte having V⁴⁺/V⁵⁺ are exchanged with electrolyte having V²⁺/V³⁺ to correct the positive imbalance.

10. The flow cell system of claim 1, wherein electrolyte having V²⁺/V³⁺ are exchanged with electrolyte having V⁴⁺/V⁵⁺ to correct the negative imbalance.

11. The flow cell system of claim 1, wherein the rebalance system is controlled by a controller and integrated into a firmware.

12. A method of rebalancing a positive imbalance in a flow cell system, comprising reducing excessive V⁵⁺.

13. The method of claim 12, wherein reducing the excessive V⁵⁺ includes
introducing a reducing agent to electrolyte having V⁴⁺/V⁵⁺;
reducing the excessive V⁵⁺; and
adjusting molar amount of V⁵⁺ to achieve rebalanced molar amount between V²⁺ and V⁵⁺.

14. The method of claim 13, wherein the reducing agent includes a mild organic reducing agent, the mild organic reducing agent comprising at least one of alcohol, methanol, ethylene glycol, glycerol, organic acid, formic acid, oxalic acid and glycerol.

15. The method of claim 12, wherein reducing the excessive V⁵⁺ includes
exchanging electrolyte having V⁴⁺/V⁵⁺ with electrolyte having V²⁺/V³⁺; and
adjusting molar amount of V⁵⁺ to achieve rebalanced molar amount between V²⁺ and V⁵⁺.

16. A method of rebalancing a negative imbalance in a flow cell system, comprising oxidizing excessive V²⁺.

17. The method of claim 16, wherein oxidizing the excessive V²⁺ includes
introducing an oxidizing agent to electrolyte having V³⁺/V²⁺;
oxidizing the excessive V²⁺; and
adjusting molar amount of V²⁺ to achieve rebalanced molar amount between V²⁺ and V⁵⁺.

18. The method of claim 17, wherein the oxidizing agent is comprised of at least one of oxygen gas, hydrogen peroxide, chlorine, or vanadium ions in oxidation state 5+ or 4+

19. The method of claim 16, wherein oxidizing the excessive V²⁺ includes
introducing air into the flow cell system;
oxidizing the excessive V²⁺; and
adjusting molar amount of V²⁺ to achieve the rebalanced molar amount between V²⁺ and V⁵⁺.

20. The method of claim 16, wherein the oxidation of the excessive V²⁺ includes
exchanging electrolyte having V²⁺/V³⁺ with electrolyte having V⁴⁺/V⁵⁺; and
adjusting molar amount of V²⁺ to achieve the rebalanced molar amount between V²⁺ and V⁵⁺.
